(19) United States
(12) Patent Application Publication
(10) Pub. No.: US 2016/0232104 A1
(43) Pub. Date: Aug. 11, 2016

(54) SYSTEM, METHOD AND NON-TRANSITORY COMPUTER READABLE MEDIUM

(71) Applicant: FUJITSU LIMITED, Kawasaki-shi (JP)

(72) Inventors: Kazuhiko IKEUCHI, Kawasaki (JP); Chikashi Maeda, Kawasaki (JP); Kazuhiro URATA, Kawasaki (JP); Yukari Tsuchiyama, Kawasaki (JP); Takeshi WATANABE, Kawasaki (JP); Guangyu ZHOU, Kawasaki (JP)

(21) Appl. No.: 15/018,055

(22) Filed: Feb. 8, 2016

(30) Foreign Application Priority Data
Feb. 10, 2015 (JP) 2015-024530

(51) Int. Cl. G06F 12/10

(52) U.S. Cl. CPC G06F 12/10; G06F 2212/1041; G06F 2212/262; G06F 2212/65

(57) ABSTRACT

A system that sets a logical volume in a first physical address region of a storage device including a plurality of memory areas, receives a write request to write data to a first logical address of the logical volume, calculates a difference between a first physical address corresponding to the first logical address and a head physical address of a first memory area of the plurality of memory areas, changes, based on the calculated difference, a first physical address region of the logical volume in the storage device to a second physical address region of the storage device, and writes the data to the first logical address of the logical volume set in the second physical address region of the storage device.

### CROSS-REFERENCE TO RELATED APPLICATION

This application is based upon and claims the benefit of priority of the prior Japanese Patent Application No. 2015-024530, filed on Feb. 10, 2015, the entire contents of which are incorporated herein by reference.

### FIELD

The embodiment discussed herein is related to a system, a method and a non-transitory computer-readable medium.

### BACKGROUND

Conventionally, there have been storage devices which have a redundant arrays of inexpensive disks (RAID) configuration in which data is made redundant by plurality of memory devices. As related art, for example, there is a technology in which, when a logical address indicating a start position of a write of received data does not match an offset of a parity calculation block, the logical address is converted so as to match the offset. Also, for example, there is a technology in which padding data is added to a surplus generated by data of 4096 bytes relative to the size of 3584 bytes. Japanese Laid-open Patent Publication No. 2001-256001 and Japanese Laid-open Patent Publication No. 09-330178 discuss related art.

### SUMMARY

According to an aspect of the invention, a system sets a logical volume in a first physical address region of a storage device including a plurality of memory areas; receives a write request to write data to a first logical address of the logical volume, calculates, a difference between a first physical address corresponding to the first logical address and a head physical address of a first memory area of the plurality of memory areas, changes, based on the calculated difference, a first physical address region of the logical volume in the storage device to a second physical address region of the storage device, and writes the data to the first logical address of the logical volume set in the second physical address region of the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a storage control device according to an embodiment;

FIG. 2 is an explanatory diagram illustrating an example of a storage system;

FIG. 3 is an explanatory table illustrating an example of memory contents of a setting table;

FIG. 4 is an explanatory table illustrating an example of memory contents of a management table;

FIG. 5 is an explanatory table illustrating an example of memory contents of an offset table;

FIG. 6 is a block diagram illustrating a functional configuration example of a control device;

FIG. 7 is an explanatory diagram illustrating an example in which the control device receives a data write request in a first operation example;

FIG. 8 is an explanatory table illustrating an example in which the control device determines an offset in the first operation example;

FIG. 9 is an explanatory diagram illustrating an example in which the control device rearranges data of a logical volume in the first operation example;

FIG. 10 is an explanatory diagram illustrating an example in which the control device receives a data write request in a second operation example;

FIG. 11 is an explanatory table illustrating an example in which the control device determines an offset in the second operation example;

FIG. 12 is an explanatory diagram illustrating an example in which the control device rearranges data of a logical volume in the second operation example;

FIG. 13 is a flow chart illustrating an example of generation processing steps;

FIG. 14 is a flow chart illustrating an example of monitoring processing steps;

FIG. 15 is a flow chart illustrating an example of evaluation processing steps; and

FIG. 16 is a flow chart illustrating an example of rearrangement processing steps.

### DESCRIPTION OF EMBODIMENT

### Example of Storage Control Device According to Embodiment

According to a known technology, when a data write in which a write penalty and a read-modify-write occur is frequently requested to a logical volume generated in a storage device, the write performance of the storage device is reduced.

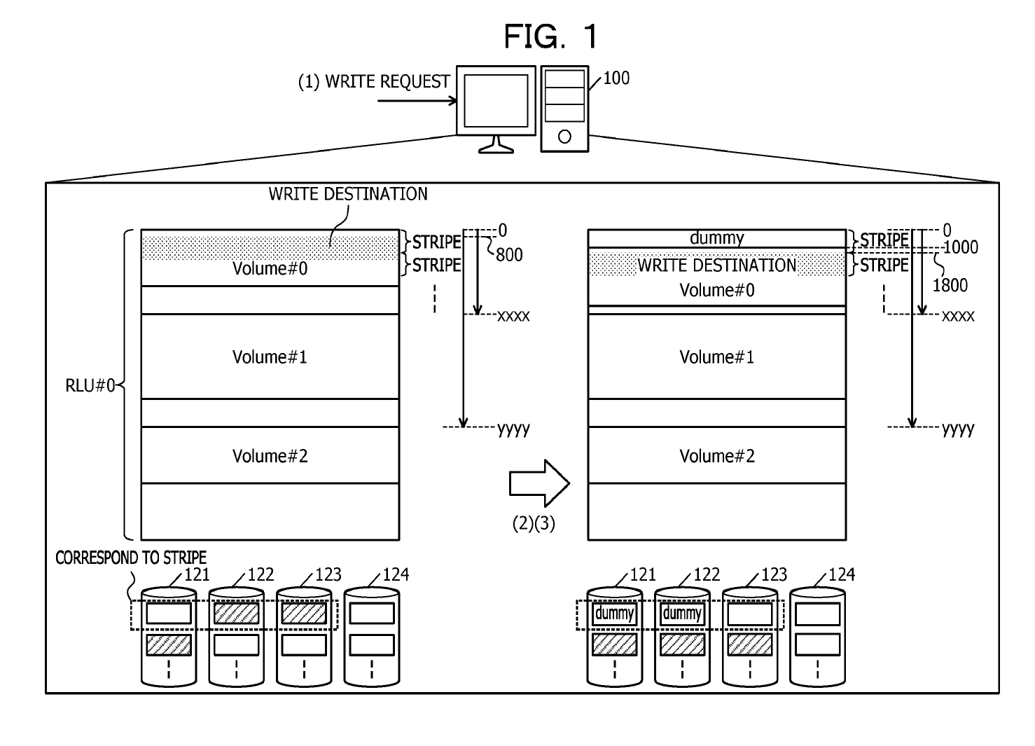

FIG. 1 is an explanatory diagram illustrating an example of a storage control device 100 according to an embodiment. In FIG. 1, the storage control device 100 is a computer that includes one or more storage devices and controls the one or more storage devices. In the following description, the storage control device 100 might also be referred to as the “control device 100”. Each of the one or more storage devices includes one or more memory devices. The one or more memory devices are, for example, magnetic disks, optical disks, flash memories, magnetic tapes, and the like. In each of the one or more storage devices, one or more logical volumes are formed.

Each of the one or more logical volumes is divided by memory areas in predetermined management units. For example, the logical volume is divided in units of stripes. Each of the stripes is a memory area in which a data array is stored in accordance with a combination of some of the plurality of memory devices. A parity acquired from the data array stored in a stripe is stored in one of the plurality of memory devices. When a part of the data array stored in the stripe is updated, the storage device recalculates a parity. The logical volume is divided, for example, in units of respective sectors of the one or more memory devices. Data is written to the logical volume in units of sectors. If data that is to be written to the logical volume is not data that is writable in units of sectors, the data is corrected to be data that is writable in units of sectors.

There is a case where a known arithmetic device writes data in a memory area that is not a stripe unit on a logical volume generated in a storage device. However, in this case, the known arithmetic device reads out data used for parity calculation in advance of a write, calculates a parity, and then, performs a write of the data and the parity, thereby causing reduction in write performance. The operation of reading out other data used for parity calculation, calculating a parity, and performing a write of the data and the parity herein will be referred to as the “write penalty (WP)”.

Specifically, in a write penalty, a read of data used for parity calculation is performed in performing a write of data for which a write request was made, so that the number of accesses to the memory device is increased and a write performance is reduced. On the other hand, in a case where data is written in a memory area in units of stripes, a write penalty is not performed, so that a read of other data used for parity calculation is not performed and the number of accesses is not increased. Therefore, when a write penalty is performed, a write performance is reduced, as compared to a case where a write penalty is not performed.

Also, there is a case where the known arithmetic device writes data in a memory area that is not a sector unit on a logical volume generated on a storage device. However, in this case, the known arithmetic device reads out other data used for data correction in advance of writing data, corrects the data to data that is writable in units of sectors, and then, writes corrected data, thereby causing reduction in write performance. In the following description, the other data used for data correction might be also referred to as the “correction data”. In this case, the operation of reading out correction data used for data correction in advance of writing data, correcting the data to data writable in units of sectors, and writing corrected data is referred to as the “read-modify-write (RMW)”.

Specifically, in a read-modify-write, a write is not performed only with data for which a write request was made, and thus, a read of correction data is performed, so that the number of accesses to a memory device is increased, thereby causing reduction in write performance. In a case where data is written in a memory area in units of sectors, on the other hand, a read-modify-write is not performed, and thus, a read of correction data is not performed, so that the number of accesses is not increased. Therefore, when a read-modify-write is performed, a write performance is reduced, as compared to a case where a read-modify-write is not performed.

As has been described above, in a case where a data write to a memory area deviated from a memory area that is a predetermined management unit is performed, a known arithmetic device reads out data in advance of writing data, thereby causing reduction in write performance. Therefore, in this embodiment, a control method that may reduce reduction in write performance will be described.

In FIG. 1, the control device 100 calculates, based on a write position of data for which a write request to a logical volume was made, a deviation amount of the write position from a boundary of a memory area that is a management unit on a logical volume. The write position is a position in which a head of data is written. Also, the write position may be a position in which an end of data is written. Then, the control device 100 rearranges data of the logical volume on a physical area of the storage device, based on the deviation amount. Thus, the control device 100 may reduce reduction in write performance when the write position of data for which a write request is made next time or later are the same as the write position of data for which a write request was made this time.

In the example of FIG. 1, the storage device includes four disks 121 to 124. The stripe is, for example, a memory area in which a data array is stored so as to extend over three of the four disks, that is, the disks 121 to 123. The parity of the stripe is stored by the rest of the four disks, that is, the disk 124. Specifically, the stripe includes a memory area of “1 MB=0x800 blocks” of each of the three disks 121 to 123, and is a memory area of “3 MB=0x1800blocks”. One block is a memory area of 512 B.

In the storage device, logical volumes #0 to #2 are formed. A head position of the logical volume #0 is located in a position of a logical block addressing (LBA) “0th block”, which is a head position of a logical area RLU#0 of the storage device. In the following description, the number of blocks used in specifying an amount by which the head position of the logical volume #0 is to be deviated from the head position of the logical area RLU#0 of the storage device might be also referred to as the “offset”. The initial offset of the logical volume #0 is “0”.

The head position of the logical volume #1 is located in a position of a LBA “xxxxth block” of the logical area RLU#0 of the storage device. The initial offset of the logical volume #1 is “xxxx”. The head position of the logical volume #2 is located in a LBA “yyyyth block (yyyy>xxxx)” of the logical area RLU#0 of the storage device. The initial offset of the logical volume #2 is “yyyy”.

(1) The control device 100 receives a data write request to the logical volume #0. The write request includes a data write position “0x800th block” based on the head position of the logical volume #0 as a reference.

(2) The control device 100 divides the data write position “0x800th block” by the size “0x1800 blocks” of the stripe. Then, the control device 100 calculates, as the deviation amount of the data write position from the boundary of the stripe of the logical volume #0, a remainder “0x800 blocks” when the division is performed.

(3) The control device 100 rearranges data of the logical volume #0 on the physical area of the storage device, based on the calculated deviation amount. Specifically, the control device 100 inserts dummy data that has a size corresponding to the deviation amount in the head of the data of the logical volume #0 on the physical area of the storage device, and thus, rearranges the data. The dummy data has a size corresponding to a difference “0x1000 blocks” when the deviation amount “0x800 blocks” is subtracted from the size “0x1800 blocks” of the stripe.

Thus, the control device 100 adds an offset of a size corresponding to the deviation amount to an initial offset of the logical volume, and thus, deviates the head position of the logical volume. As a result, when the write position of data for which a write request is made next time or later are the same as the write position of data for which a write request was made this time, the control device 100 may reduce reduction of write performance. Specifically, when a remainder when the write position of data for which a write request is made next time or later is divided by the size of the stripe is the same as that of the data for which a write request was made this time, the control device 100 may reduce reduction in write performance.

In this case, a case where the control device 100 calculates a deviation amount by dividing the write position “0x800th block” based on the head position of the logical volume #0 as a reference by the size “0x1800 blocks” of the stripe has been described, but the embodiment is not limited thereto. For example, there is a case where the control device 100 receives a write request including a write position “0x800th block” based on the head position of the logical volume #1 as a reference. In this case, the control device 100 calculates a deviation amount by dividing “0x800+xxxxth block” obtained by adding the offset “xxxx” of the logical volume #1 to the write position “0x800th block” by the size “0x1800 blocks” of the stripe. Then, the control device 100 rearranges the data of the logical volume #1, based on the deviation amount.

There is also a case where, after an offset “0x1000” is added to the initial offset “0” of the logical volume #0, the control device 100 receives a write request including a write position “0x400th block” based on the head position of the logical volume #0 as a reference again. In this case, the control device 100 calculates a deviation amount by dividing a “0x1400th block” obtained by adding the offset “0x1000” of the logical volume #0 to the write position “0x400th block” by the size “0x1800 blocks” of the stripe.

### Example of Storage System 200

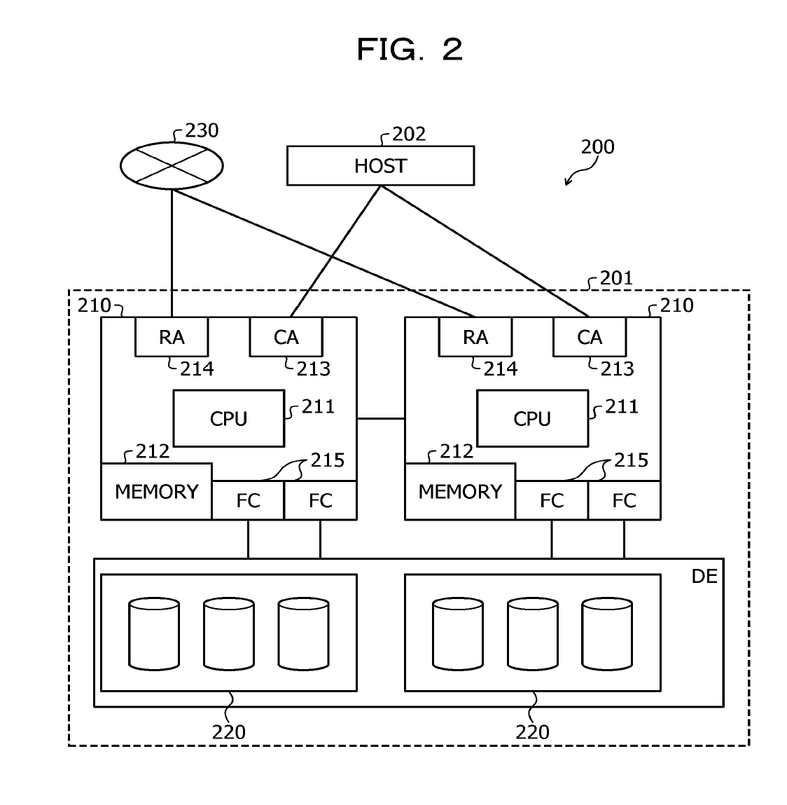

Next, an example of a storage system 200 to which the control device 100 illustrated in FIG. 1 is applied will be described with reference to FIG. 2.

FIG. 2 is an explanatory diagram illustrating an example of the storage system 200. In FIG. 2, the storage system 200 includes a RAID device 201 and a host device 202. In this case, the RAID device 201 is, for example, a computer that operates as the control device 100 illustrated in FIG. 1.

The RAID device 201 includes two control modules (CMs) 210 and two storage devices 220. Each of the CMs 210 includes a central processing unit (CPU) 211, a memory 212, a channel adapter (CA) 213, a remote adapter (RA) 214, and a fibre channel (FC) 215.

The CPU 211 controls the entire CM 210. The CPU 211 executes a program stored in the memory 212 to operate the CM 210. The memory 212 stores a boot program and various types of tables, which will be described later. Also, the memory 212 is used as a work area of the CPU 211. The memory 212 includes a read only memory (ROM), a random access memory (RAM), a flash ROM, and the like.

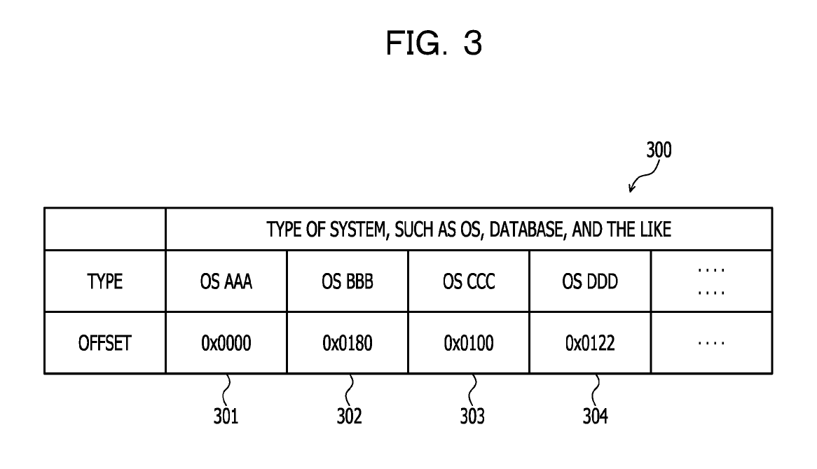

Specifically, the flash ROM stores an operation system (OS) and a program, such as a firmware and the like. Specifically, the ROM stores an application program. Specifically, the RAM is used as a work area of the CPU 211. Specifically, the RAM stores various types of tables, such as a setting table 300, which will described later with reference to FIG. 3, and the like. The program stored in the memory 212 is loaded to the CPU 211, and thereby, causes the CPU 211 to execute coded processing.

The CA 213 controls an interface with an external device, such as the host device 202 and the like. The RA 214 controls the interface with the external device coupled with the RA 214 via a network 230 or an exclusive line. The FC 215 controls an interface with the corresponding one of the storage devices 220. The storage devices 220 are used for realizing a logical volume. For example, each of the storage devices 220 includes one or more memory devices. The storage devices 220 are mounted on a disk enclosure (DE).

Also, the host device 202 is, for example, a computer that transmits a write request and the like to the RAID device 201. Specifically, the host device 202 is a personal computer (PC), a note PC, a mobile phone, a smart phone, a tablet terminal, personal digital assistants (PDA), or the like.

In this case, a case where the RAID device 201 includes the two CMs 210 has been described, but the embodiment is not limited thereto. For example, the RAID device 201 may include a single CM 210, or may include four or more CMs 210. Also, a case where the CM 210 includes a single CA 213, a single RA 214, and a single FC 215 has been described, but the embodiment is not limited thereto. For example, one of the respective numbers of the CA 213, the RA 214, and the FC 215 provided in the CM 210 may be two or more. Also, a case where the RAID device 201 operates as the control device 100 illustrated in FIG. 1 has been described, but the embodiment is not limited thereto. For example, each of the CMs 210 or one of the CMs 210 may operate as the control device 100 illustrated in FIG. 1.

### Storage Contents of Setting Table 300

Next, an example of storage contents of the setting table 300 will be described with reference to FIG. 3. The setting table 300 may be realized by a memory area of the memory 212 illustrated in FIG. 2.

FIG. 3 is an explanatory table illustrating an example of memory contents of the setting table 300. As illustrated in FIG. 3, the setting table 300 includes an offset entry associated with a type entry, information is set to each entry for each system type, such as an OS, a database (DB), and the like, and thus, stores records 301 to 304.

In the type entry, the type of a system, such as an OS, a DB, and the like, which may be realized by the host device 202, is stored. When the host device 202 is a computer that realizes the system, such as an OS, a DB, and the like, of the type in the type entry, an offset indicating an amount by which a start position of the logical volume is to be moved is stored in the offset entry.

For example, assume a case where a probability that a system of a type “OS AAA” uses a logical volume from the head of the logical volume as a data write destination is high. In this case, a write position is not adjusted in realizing the system of the type “OS AAA”, and therefore, the setting table 300 stores the record 301 in which the offset “0x0000” is associated with the type “OS AAA”.

Assume a case where a probability that a system of a type “OS BBB” does not use a head portion of the logical volume and uses, as a data write destination, a 0x180th block from the head of the logical volume and subsequent blocks is high. In this case, the setting table 300 stores the record 302 in which an offset “0x0180” is associated with the type “OS BBB” such that a write penalty is not performed in realizing the system of the type “OS BBB”.

Assume a case where a probability that, similar to the type “OS BBB”, a system of a type “OS CCC” does not use the head portion of the logical volume and uses, as a data write destination, a 0x0100th block from the head of the logical volume and subsequent blocks is high. In this case, the setting table 300 stores the record 303 in which an offset “0x0100” is associated with the type “OS CCC” such that a write penalty is not performed in realizing the system of the type “OS CCC”.

Assume a case where a probability that, similar to the type “OS BBB”, a system of a type “OS DDD” does not use the head portion of the logical volume and uses, as a data write destination, a 0x0122th block from the head of the logical volume and subsequent blocks is high. In this case, the setting table 300 stores the record 304 in which an offset “0x0122” is associated with the type “OS DDD” such that a write penalty is not performed in realizing the system of the type “OS DDD”.

### Storage Contents of Management Table 400

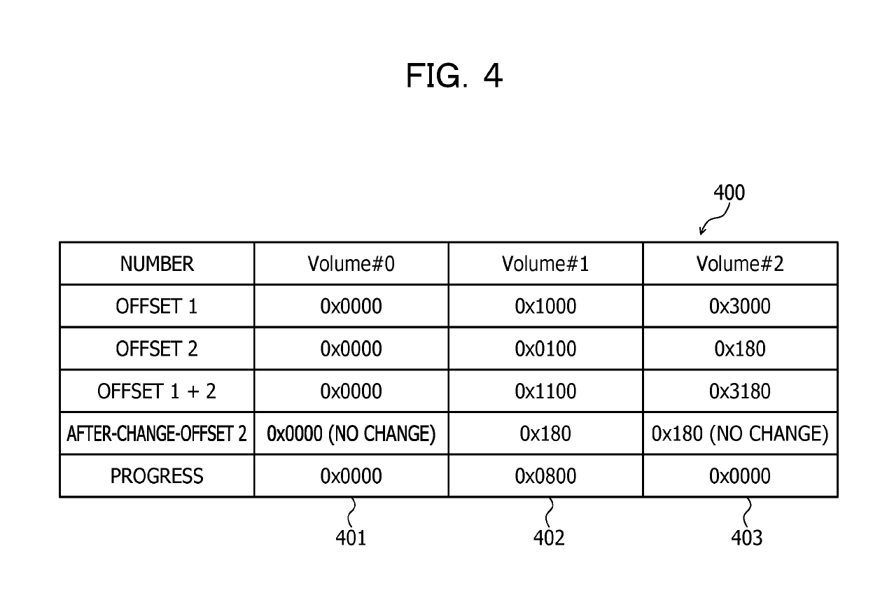

Next, an example of storage contents of a management table 400 will be described with reference to FIG. 4. The management table 400 is realized, for example, by a memory area of the memory 212 illustrated in FIG. 2.

FIG. 4 is an explanatory table illustrating an example of memory contents of the management table 400. As illustrated in FIG. 4, the management table 400 includes an offset 1 entry, an offset 2 entry, an offset 1+2 entry, an after-change-offset 2 entry, and a progress entry in association with a number entry. Information is set to each entry for each logical volume, and thus, the management table 400 stores records 401 to 403.

In the number entry, a number given to a logical volume is stored. In the offset 1 entry, an offset 1 indicating an amount by which a start position of the logical volume which the number in the number entry is given is to be moved from a head position of a logical area is stored.

In the offset 2 entry, an offset 2 indicating an amount by which a start position of the logical volume to which the number in the number entry is given is to be further moved, in addition to the offset 1 in the offset 1 entry, is stored. In the offset 2 entry, for example, as the offset 2, an offset in the offset entry of the setting table 300 is stored.

In the offset 1+2 entry, the sum of the offset 1 in the offset 1 entry and the offset 2 in the offset 2 entry is stored. In converting a position on a logical volume, which is a write position of data for which a write request was made by the host device 202, to a position on a logical area, a value in the offset 1+2 entry is added to the data write position. If the offset 2 in the offset 2 entry is changed, the value of the offset 2 after the offset 2 is changed is stored in the after-change-offset 2 entry. In the progress entry, the degree of progress of change of the offset 2 in the offset 2 entry is stored.

### Storage Contents of Offset Table 500

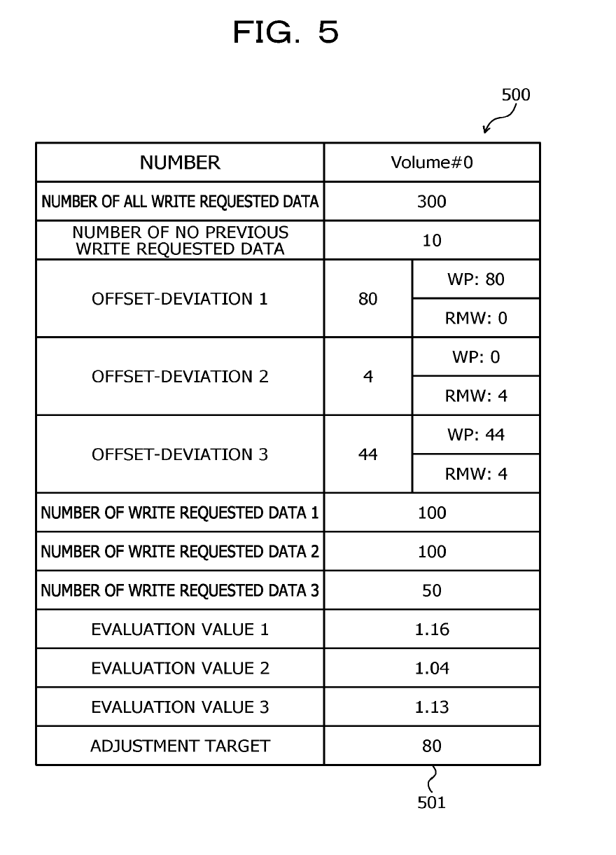

Next, an example of storage contents of an offset table 500 will be described with reference to FIG. 5. The offset table 500 is realized, for example, by a memory area of the memory 212 illustrated in FIG. 2.

FIG. 5 is an explanatory table illustrating an example of memory contents of the offset table 500. As illustrated in FIG. 5, the offset table 500 includes a number-of-all-write-requested-data entry and a number-of-no-previous-write-requested-data entry in association with a number entry. The offset table 500 includes an offset-deviation 1 entry, an offset-deviation 2 entry, and an offset-deviation 3 entry in association with the number entry.

The offset table 500 includes the number-of-write-requested-data 1 entry, a number-of-write-requested-data 2 entry, and a number-of-write-requested-data 3 entry in association with the number entry. The offset table 500 includes an evaluation-value 1 entry, an evaluation-value 2 entry, an evaluation-value 3 entry, and an adjustment target entry in association with the number entry. Information is set to each entry for each logical volume, and thus, the offset table 500 stores a record 501 and the like.

In the number entry, a number given to a logical volume is stored. In the number-of-all-write-requested-data entry, the number of pieces of data for which a write request to the logical volume which the number in the number entry is given was made is stored. In the number-of-no-previous-write-requested-data entry, the number of pieces of data, among the pieces of data for which the write request was made, the number of which is described in the number-of-all-write-requested-data entry, which may be written to the physical area of the storage device without performing a write penalty and a read-modify-write, is stored.

In the offset-deviation 1 entry, an offset-deviation 1 that is a deviation amount of a write position of data for which a write request was made from a boundary of a memory area that is a management unit on a logical volume is stored. WP is an offset, among deviation amounts, in reducing reduction in write performance due to a write penalty. RMW is an offset, among deviation amounts, in reducing reduction in write performance due to a read-modify-write.

In the offset-deviation 2 entry, an offset-deviation 2 that is a different deviation amount from the offset-deviation 1 and is a deviation amount of a write position of data for which a write request was made from a boundary of a memory area that is a management unit on the logical volume is stored. In the offset-deviation 3 entry, an offset-deviation 3 that is a different deviation amount from the offset-deviation 1 and the offset-deviation 2 and is a deviation amount of a write position of data for which a write request was made from a boundary of a memory area that is a management unit on the logical volume is stored.

In the number-of-write-requested-data 1 entry, the number of pieces of data, among pieces of data for which a write request was made, the number of which is described in the number-of-all-write-requested-data entry, for which the deviation amount in the offset-deviation 1 entry was calculated, is stored. In the number-of-write-requested-data 2 entry, the number of pieces of data, among pieces of data for which a write request was made, the number of which is described in the number-of-all-write-requested-data entry, for which the deviation amount of the offset-deviation 2 entry was calculated, is stored. In the number-of-write-requested-data 3 entry, the number of pieces of data, among pieces of data for which a write request was made, the number of which is described in the number-of-all-write-requested-data entry, for which the deviation amount of the offset-deviation 3 entry was calculated, is stored.

In the evaluation-value 1 entry, the evaluation value of an access performance of the logical volume to which the number in the number entry is given when data of the logical volume to which the number in the number entry is given is rearranged on the physical area of the storage device, based on the deviation amount in the offset-deviation 1 entry, is stored. In the evaluation-value 2 entry, the evaluation value of an access performance of the logical volume to which the number in the number entry is given when data of the logical volume to which the number in the number entry is given is rearranged on the physical area of the storage device, based on the deviation amount in the offset-deviation 2 entry, is stored.

In the evaluation-value 3 entry, the evaluation value of an access performance of the logical volume to which the number of the number entry is given when data of the logical volume to which the number in the number entry is given is rearranged on the physical area of the storage device, based on the deviation amount in the offset-deviation 3 entry, is stored. In the adjustment target entry, a deviation amount with which the evaluation value is the largest is stored.

### Functional Configuration Example of Control Device 100

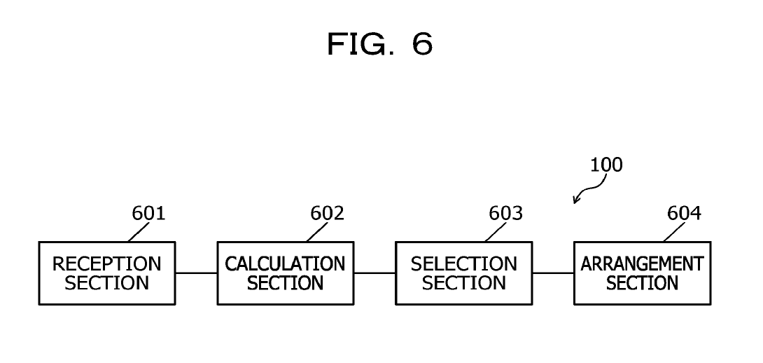

Next, a functional configuration example of the control device 100 will be described with reference to FIG. 6.

FIG. 6 is a block diagram illustrating a functional configuration example of the control device 100. The control device 100 includes, as a function serving as a control section, a reception section 601, a calculation section 602, a selection section 603, and an arrangement section 604.

The reception section 601 receives a data write request to a logical volume generated in a storage device of a RAID structure. For example, the reception section 601 receives a data write request including the size and write position of the data from the host device 202, thereby receiving the data write request. Specifically, the reception section 601 receives a data write request to a logical volume #0, which includes the size “6 MB=0x3000 blocks” of the data, and the write position “0x800th block” of the data. Thus, the reception section 601 outputs, to the calculation section 602, the size and write position of the data included in the data write request.

The write request received by the reception section 601 is stored, for example, in the memory 212. The reception section 601 realizes the function thereof, for example, by causing the CPU 211 to execute a program stored in the memory 212 illustrated in FIG. 2 or using the CA 213 and the RA 214.

The calculation section 602 calculates, based on the size and write position of the data included in the write request received by the reception section 601, a deviation amount of the write position from a boundary of a memory area that is a management unit on the logical volume. The memory area that is a management unit is, for example, a stripe or a sector.

For example, the calculation section 602 calculates the deviation amount of the write position from a boundary of a stripe on the logical volume. Specifically, if the size of data matches an integral multiple of the size of the stripe, the calculation section 602 calculates, as the deviation amount, the value of a remainder when the address of the write position is divided by the size of the stripe. If the calculation section 602 determines that the size of data does not match the integral multiple, the calculation section 602 does not calculate the deviation amount.

More specifically, the calculation section 602 divides the size “6 MB =0x3000 blocks” of the data by the size “0x1800 blocks” of the stripe. In this case, the remainder when the division is performed is “0”, and thus, the calculation section 602 determines that the size of the data matches an integral multiple of the size of the stripe. Next, the calculation section 602 divides the write position “0x800th block” of the data by the size “0x1800 block” of the stripe. Then, the calculation section 602 calculates, as the deviation amount of the write position of the data from the boundary of the stripe on the logical volume of the storage device, the remainder “0x800 blocks” when the division is performed.

Also, the calculation section 602 calculates, for example, the deviation amount of the write position from a boundary of a sector on the logical volume of the storage device. Specifically, if the size of the data matches an integral multiple of the size of the sector, the calculation section 602 calculates, as the deviation amount, the value of a remainder when the address of the write position is divided by the size of the sector.

More specifically, the calculation section 602 divides the size “4 KB=0x8 blocks” of the data by the size “0x8 blocks” of the sector. In this case, the remainder when the division is performed is “0”, and therefore, the calculation section 602 determines that the size of the data matches an integral multiple of the size of the sector. Next, the calculation section 602 divides the write position “0x4th block” of the data by the size “0x8 blocks” of the sector. Then, the calculation section 602 calculates, as the deviation amount of the write position of the data from the boundary of the sector on the logical volume of the storage device, the remainder “0x4 blocks” when the division is performed.

A case where, when the size of the data for which a write request was made matches an integral multiple of the size of the stripe or the sector, the calculation section 602 calculates the deviation amount has been described above, but the embodiment is not limited thereto. For example, if the size of the data for which the write request was made is larger than the size of the stripe, the calculation section 602 may calculate the deviation amount, even when the size of the data does not match an integral multiple of the size of the stripe.

For example, the calculation section 602 may calculate, for each data for which a write request to a logical volume was made, the deviation amount of the write position of the data from the boundary of the memory area that is a management unit. Then, the calculation section 602 calculates the number of deviation amounts respective values of which are the same, among deviation amounts calculated for each data for which a write request was made.

The calculation section 602 sets the deviation amount calculated for each data for which a write request was made to the offset-deviation 1 entry of the offset table 500 and the like. Also, the calculation section 602 sets the number of deviation amounts respective values of which are the same and the like to the number-of-write-requested-data 1 entry of the offset table 500 and the like. Thus, the calculation section 602 calculates the deviation amount of the write position of the data, which is used for selecting an offset indicating an amount by which a start position of the logical volume is to be deviated.

The deviation amount calculated by the calculation section 602 is stored, for example, in the memory 212. Specifically, the deviation amount calculated by the calculation section 602 is stored in the offset table 500 of the memory 212. The calculation section 602 realizes the function thereof, for example, by causing the CPU 211 to execute the program stored in the memory 212 illustrated in FIG. 2.

The selection section 603 selects one of the deviation amounts calculated by the calculation section 602. The selection section 603 calculates, for example, based on the number of deviation amounts calculated by the calculation section 602, the evaluation value of an access performance when data of the logical volume is rearranged based on each of the deviation amounts calculated by the calculation section 602 for each data for which a write request was made. Then, the selection section 603 selects one of the deviation amounts with which the calculated evaluation value is the largest.

Specifically, the selection section 603 acquires the deviation amount “80” in the offset-deviation 1 entry and the number “100” of pieces of data in the number-of-write-requested-data 1 entry with reference to the offset table 500. If the acquired deviation amount is “8=4 KB” or more, the selection section 603 assumes that there is a probability that the write performance is reduced due to a write penalty, and causes the process to proceed to calculation of the evaluation value of an access performance when rearrangement is performed based on the deviation amount “80”. In this case, it is assumed that, as compared to a write performance when a data write is performed by performing a write penalty, the write performance when a data write is performed without performing a write penalty is 1.5 times greater.

When data is rearranged based on the deviation amount “80”, the pieces the number of which in the number-of-write-requested-data 1 entry is “100” are writable without performing a write penalty. Thus, if the number “100” of pieces of data in the number-of-write-requested-data 1 entry is large, the selection section 603 performs selection such that an evaluation value when data is rearranged based on the deviation amount “80” is large. If data is rearranged based on the deviation amount “80”, for pieces of data the number of which in the number-of-no-previous-write-requested-data entry is “10”, a write penalty or a read-modify-write is performed. Therefore, if the number “10” of pieces of data in the number-of-no-previous-write-requested-data entry is large, the selection section 603 performs selection such that an evaluation value when data is rearranged based on the deviation amount “80” is small.

Also, it is unknown whether or not a write penalty or a read-modify-write is to be performed for pieces of data of the number of remaining pieces of data, that is, “300−100−10=190”. Based on the foregoing, the selection section 603 calculates, as an evaluation value when data is rearranged based on the deviation amount “80”, {(100×1.5)+(10/1.5)+(190)}/300=1.16. The selection section 603 sets the calculated evaluation value to the evaluation-value 1 entry of the offset table 500.

Also, the selection section 603 acquires the deviation amount “4” in the offset-deviation 2 entry and the number “100” of pieces of data in the number-of-write-requested-data 2 entry with reference to the offset table 500. If the deviation amount is a value that is not divisible by “8=4 KB”, the selection section 603 assumes that there is a probability that a write performance is reduced due to a read-modify-write, and causes the process to proceed to calculation of the evaluation value of an access performance when data is rearranged based on the deviation amount “4”. In this case, it is assumed that, as compared to a write performance when a data write is performed by performing a read-modify-write, the write performance when a data write is performed without performing a read-modify-write is 1.2 times greater.

When data is rearranged based on the deviation amount “4”, for pieces of data the number of which in the number-of-write-requested-data 1 entry is “100”, a read-modify-write is performed. Thus, if the number “100” of pieces of data in the number-of-write-requested-data 1 entry is large, the selection section 603 performs selection such that an evaluation value when data is rearranged based on the deviation amount “4” is small. Also, when data is rearranged based on the deviation amount “4”, pieces of data the number of which in the number-of-write-requested-data 2 entry is “100” are writable without performing a read-modify-write. Therefore, if the number “100” of pieces of data in the number-of-write-requested-data 2 entry is large, the selection section 603 performs selection such that an evaluation value when data is rearranged based on the deviation amount “4” is large.

Also, when data is rearranged based on the deviation amount “4”, pieces of data the number of which in the number-of-write-requested-data 3 entry is “50” are writable without performing a read-modify-write. Therefore, if the number “50” of pieces of data in the number-of-write-requested-data 3 entry is large, the selection section 603 performs selection such that an evaluation value when data is rearranged based on the deviation amount “4” is large. Also, when data is rearranged based on the deviation amount “4”, for pieces of data the number of which in the number-of-no-previous-write-requested-data entry is “10”, a write penalty or a read-modify-write is performed. Therefore, if the number “10” of pieces of data in the number-of-no-previous-write-requested-data entry is large, the selection section 603 performs selection such that an evaluation value when data is rearranged based on the deviation amount “4” is small.

Also, it is unknown whether or not a write penalty or a read-modify-write is to be performed for pieces of data of the number of remaining pieces of data, that is, “300−100−100−50−10=40”. Based on the foregoing, the selection section 603 calculates, as an evaluation value when data is rearranged based on the deviation amount “4, {(100/1.2)+(100×1.2)+(50×1.2)+(10/1.2)+(40)}/300=1.04. The selection section 603 sets the calculated evaluation value to the evaluation-value 2 entry of the offset table 500.

Also, the selection section 603 acquires the deviation amount “44” in the offset-deviation 3 entry and the number “50” of pieces of data in the number-of-write-requested-data 3 entry with reference to the offset table 500. If the acquired deviation amount is “8=4 KB” or more and is not divisible by “8=4 KB”, the selection section 603 assumes that there is a probability that a write performance is reduced due to a write penalty and a read-modify-write. Then, the selection section 603 causes the process to proceed to calculation of the evaluation value of an access performance when data is rearranged based on the deviation amount “44”. In this case, it is assumed that, as compared to a write performance when a data write is performed by performing a write penalty and a read-modify-write, the write performance when a data write is performed without performing a write penalty and a read-modify-write is 1.5×1.2=1.8 times greater.

When data is rearranged based on the deviation amount “44”, for pieces of data the number of which in the number-of-write-requested-data 1 entry is “100”, a read-modify-write is performed. Thus, if the number “100” of pieces of data in the number-of-write-requested-data 1 entry is large, the selection section 603 performs such that an evaluation value when data is rearranged based on the deviation amount “44” is small. When data is rearranged based on the deviation amount “44”, pieces of data the number of which in the number-of-write-requested-data 2 entry is “100” are writable without performing a read-modify-write. Therefore, if the number “100” of pieces of data in the number-of-write-requested-data 2 entry is large, the selection section 603 performs selection such that an evaluation value when data is rearranged based on the deviation amount “44” is large.

Also, when data is rearranged based on the deviation amount “44”, pieces of data the number of which in the number-of-write-requested-data 3 entry is “50” are writable without performing a write penalty and a read-modify-write. Thus, if the number “50” of pieces of data in the number-of-write-requested-data 3 entry is large, the selection section 603 performs selection such that an evaluation value when data is rearranged based on the deviation amount “44” is large. When data is rearranged based on the deviation amount “44”, for pieces of data the number of which in the number-of-no-previous-write-requested-data entry is “10”, a write penalty or a read-modify-write is performed. Therefore, if the number “10” of pieces of data in the number-of-no-previous-write-requested-data entry is large, the selection section 603 performs selection such that an evaluation value when data is rearranged based on the deviation amount “44” is small.

It is unknown whether or not a write penalty or a read-modify-write is performed for pieces of data of the number of remaining pieces of data, that is, “300−100−100−50−10=40”. Based on the foregoing, the selection section 603 calculates, as an evaluation value when data is rearranged based on the deviation amount “44”, {(100/1.2)+(100×1.2)+(50×1.8)+(10/1.8)+(40)}/300=1.13. The selection section 603 sets the calculated evaluation value to the evaluation-value 3 entry of the offset table 500.

Furthermore, the selection section 603 compares the respective evaluation values in the evaluation-value 1 entry, the evaluation-value 2 entry, and the evaluation-value 3 entry. Then, the selection section 603 selects, as the deviation amount to which the arrangement section 604 refers in performing rearrangement, the deviation amount “80” with which the evaluation value is the largest. The selection section 603 sets the selected deviation amount to the adjustment target entry of the offset table 500. Thus, the selection section 603 outputs the deviation amount to the arrangement section 604.

A case where the selection section 603 selects a deviation amount with which the evaluation value is the largest has been described above, but the embodiment is not limited thereto. For example, the selection section 603 may select the deviation amount with which the number of pieces of respective data deviation amounts of which are the same is the largest. Also, the selection section 603 may select the deviation amount with which the evaluation value is a threshold or more. Also, if there is no deviation amount with which the evaluation value is the threshold or more, the selection section 603 does not select the deviation amount. The selection section 603 may also cause rearrangement not to be performed by the arrangement section 604.

A selection result is stored, for example, in the memory 212. The selection section 603 realizes the function thereof, for example, by causing the CPU 211 to execute the program stored in the memory 212 illustrated in FIG. 2.

The arrangement section 604 rearranges, based on the deviation amount, data of the logical volume on the physical area of the storage device. For example, the arrangement section 604 rearranges, based on the deviation amount selected by the selection section 603, data of the logical volume on the physical area of the storage device. Specifically, the arrangement section 604 inserts dummy data that has a size corresponding to the deviation amount selected by the selection section 603 in the head or end of the data of the logical volume, and thus, rearranges the data on the physical area of the storage device.

More specifically, the arrangement section 604 calculates, as the size of the dummy data, a difference “0x1000 blocks” obtained by subtracting the deviation amount “0x800 blocks” selected by the selection section 603 from the size “0x1800 blocks” of the stripe. Then, the arrangement section 604 inserts the dummy data having a size “0x1000 blocks”, which has been calculated, in the head of data of the logical volume on the physical area of the storage device, and thereby rearranges the data. Thus, when the size and write position of data for which a write request is made next time or later are the same as the size and write position of data for which a write request was made this time, the arrangement section 604 may reduce reduction in write performance.

The arrangement section 604 realizes the function thereof, for example, by causing the CPU 211 to execute the program stored in the memory 212 illustrated in FIG. 2 or using the FC 215.

### First Operation Example

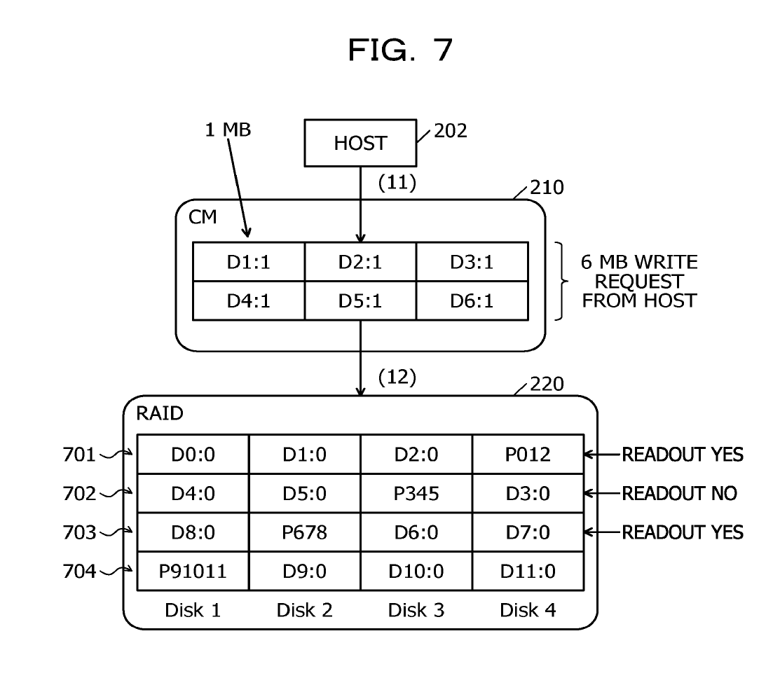

Next, a first operation example of the control device 100 will be described with reference to FIG. 7 to FIG. 9. The first operation example is an example of an operation performed in a case where, in performing a write of data for which a write request was made, the control device 100 performs a write penalty.

### Example In Which Data Write Request Is Received

FIG. 7 is an explanatory diagram illustrating an example in which the control device 100 receives a data write request in the first operation example. In FIGS. 7, D0:0 to D11:0, a parity P012, and the like are stored in the storage device 220. In the reference character Dx:y, x is the number of data. In the reference character Dx:y, y is the version of data. The parity Pijk is the parity of data Di, data Dj, and data Dk.

(11) The control device 100 receives, from the host device 202, 0x200 write requests to the logical volume. The received write requests include write requests for writing data D1:1 to data D6:1 that are to be written to a memory area that is not a stripe unit, and the like.

(12) Because the received write requests are write requests for writing data to a memory area that is not a stripe unit, the control device 100 reads out data used for parity calculation a parity from the storage device 220.

Then, the control device 100 performs a write of the pieces of data for which the write requests were made and the calculated parities to the storage device 220.

Specifically, when the control device 100 receives write requests for writing the data D1:1 to the data D6:1, the control device 100 reads out data D0:0 which is stored in a stripe 701 and is to be used for parity calculation. Next, the control device 100 calculates the parity P012 of the data D0:0, the data D1:1, and the data D2:1. Then, the control device 100 performs a write of the data D1:1, the data D2:1, and the parity P012 to the stripe 701.

Also, the control device 100 calculates a parity P345 of data D3:1 to data D5:1 for a stripe 702. Then, the control device 100 performs a write of the data D3:1 to the data D5:1 and the parity P345 to the stripe 702. In this case, the control device 100 does not perform a write penalty and does not read out data used for parity calculation, and therefore, the write performance is not reduced.

Also, the control device 100 reads out data D7:0 and data D8:0 used for parity calculation for a stripe 703. Next, the control device 100 calculates a parity P678 of the data D6:1, the data D7:0, and the data D8:0. Then, the control device 100 writes the data D6:1 and the parity P678 to the stripe 703.

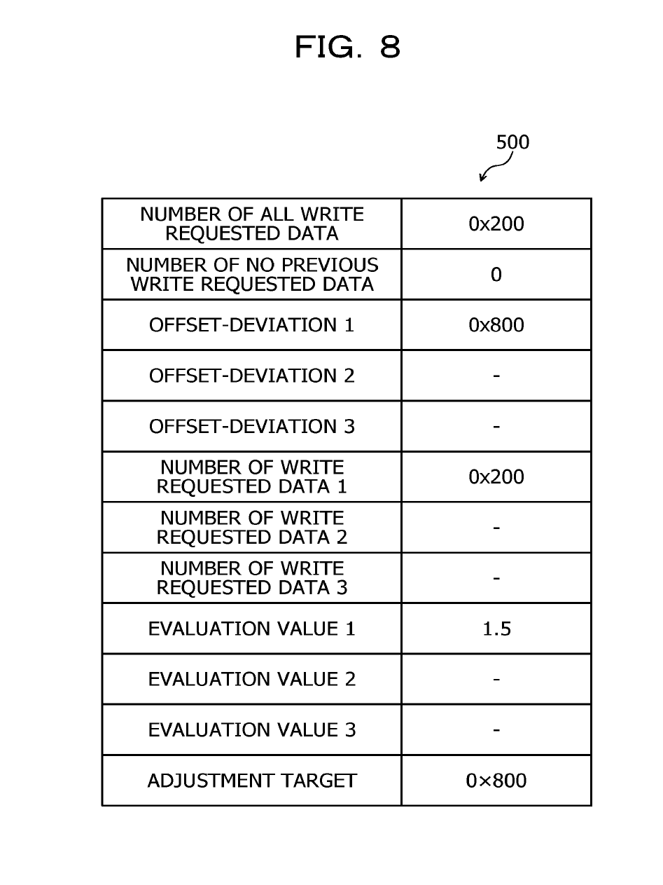

FIG. 8 will be described hereinafter. As will be described later with reference to FIG. 8, the control device 100 updates the offset table, based on the received write request in FIG. 7. Then, the control device 100 determines the offset 2 in the offset 2 entry of the management table 400 with reference to the offset table 500.

### Example In Which Offset 2 Is Determined

FIG. 8 is an explanatory table illustrating an example in which the control device 100 determines the offset 2 in the first operation example. The control device 100 sets “0x200”, which is the number of the write requests received in FIG. 7, to the number-of-all-write-requested-data entry in the offset table 500.

The control device 100 sets “0”, which is the number of write requests for writing data that may be written without performing a write penalty and a read-modify-write, among the write requests received in FIG. 7, to the number-of-no-previous-write-requested-data entry in the offset table 500.

The control device 100 calculates, for each of the write requests received in FIG. 7, a deviation amount of a write position from a boundary of a memory area that is a management unit. For example, the control device 100 calculates “0x800” as the deviation amount. Then, the control device 100 sets the deviation amount “0x800”, which has been calculated, to the offset-deviation 1 entry in the offset table 500. If there is a different deviation amount from the deviation amount in the offset-deviation 1 entry, among the deviation amounts that have been calculated, the control device 100 sets the different deviation amount to the offset-deviation 2 entry and the offset-deviation 3 entry.

The control device 100 sets the number “0x200”, which is the number of write requests for which the calculated deviation amount is the deviation amount “0x800” in the offset-deviation 1 entry, to the number-of-write-requested-data 1 entry. If there are deviation amounts that have been set to the number-of-write-requested-data 2 entry and the number-of-write-requested-data 3 entry, similar to the number-of-write-requested-data 1, the control device 100 updates the number-of-write-requested-data 2 entry and the number-of-write-requested-data 3 entry.

The control device 100 calculates the evaluation value “1.5” of the access performance of the logical volume when data of the logical volume is rearranged on a physical area of the storage device 220, based on the deviation amount in the offset-deviation 1 entry. Then, the control device 100 sets the evaluation value “1.5”, which has been calculated, to the evaluation-value 1 entry. If there are deviation amounts that have been set to the offset deviation 2 entry and the offset deviation 3 entry, similar to the evaluation-value 1, the control device 100 updates the evaluation-value 2 entry and the evaluation-value 3 entry.

The control device 100 specifies, among the deviation amounts that have been set to the offset-deviation 1 entry, the offset-deviation 2 entry, and the offset-deviation 3 entry, the deviation amount “0x800” with which the evaluation value is the largest. Then, the control device 100 sets the deviation amount “0x800”, which has been specified, to the adjustment target entry.

Furthermore, the control device 100 calculates a difference “0x1000” obtained from subtracting the deviation amount “0x800”, which has been set to the adjustment target entry, from the size “0x1800” of the stripe. Then, the control device 100 determines the difference “0x1000”, which has been calculated, as the offset 2. The control device 100 updates the offset 2 entry in the management table 400 with the determined offset 2. In this case, the offset 2 determined by the control device 100 may be used for another control device 100 that receives a write request from another host device 202 that realizes a system of the same type as that of the system of the host device 202.

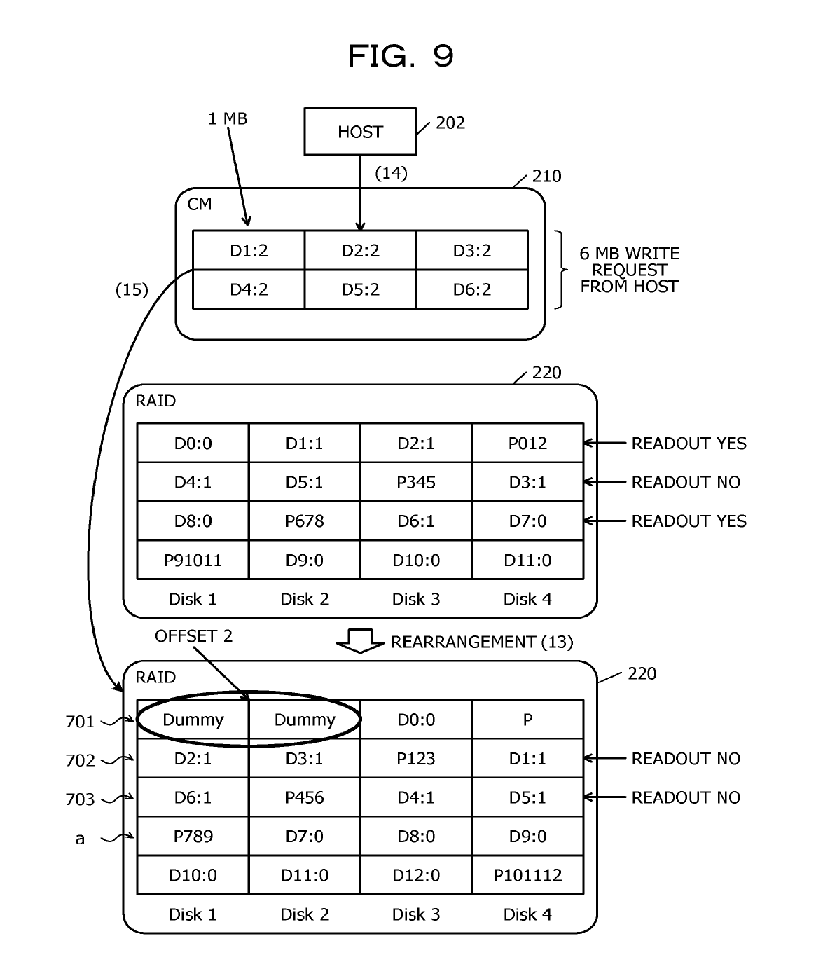

Next, FIG. 9 will be described. As will be described later with reference to FIG. 9, the control device 100 rearranges data of the logical volume on the physical area of the storage device 220, based on the determined offset 2.

### Example In Which Data Of Logical Volume Is Rearranged

FIG. 9 is an explanatory diagram illustrating an example in which the control device 100 rearranges data of a logical volume in the first operation example. In FIG. 9, (13) the control device 100 inserts dummy data that has the same size as that of the determined offset 2 in the head of the data of the logical volume, and thus, rearranges the data. Thus, the control device 100 moves the data D1:1 to the data D3:1 such that the data D1:1 to the data D3:1 are stored in a memory area that is a single stripe unit.

(14) The control device 100 receives write requests for writing data D1:2 to data D6:2 to the logical volume from the host device 202 in a similar manner to that in FIG. 7. In this case, because the write requests are received after rearrangement is performed in (13), the write requests for writing the data D1:2 to the data D6:2 are write requests for writing pieces of data to a memory area in units of stripes.

(15) Because the received write requests are write requests for writing pieces of data to a memory area in units of stripes, the control device 100 does not read out data used for parity calculation from the storage devices 220. The control device 100 calculates a parity without reading out the data. Then, the control device 100 performs a write of the pieces of data for which the write requests were made and the calculated parity to the storage device 220.

Specifically, when the control device 100 receives write requests for writing the data D1:2 to the data D6:2, the control device 100 calculates a parity P123 of the data D1:2 to the data D3:2. Then, the control device 100 performs a write of the data D1:2 to the data D3:2 and the parity P123 to the stripe 702. Also, the control device 100 calculates a parity P456 of the data D4:2 to the data D6:2. Then, the control device 100 performs a write of the data D4:2 to the data D6:2 and the parity P456 to the stripe 703.

As described above, as a result of the rearrangement of the data of the logical volume, when the control device 100 receives data write requests that are similar to those of FIG. 7, the control device 100 is enabled to perform a data write without performing a write penalty. Thus, the control device 100 may reduce reduction in write performance to the logical volume.

In this case, the control device 100 may rearrange data of the logical volume with an arbitrary timing. For example, when a write request has not been received for a certain time, the control device 100 may rearrange the data of the logical volume. Also, the control device 100 may rearrange the data of the logical volume in a time slot in which the number of write requests is statistically small.

Also, in changing the storage device to another storage device, the control device 100 may rearrange the data of the logical volume from the storage device to the another storage device. In this case, after copying data from the storage device to the another storage device in advance and performing rearrangement in the another storage device, the control device 100 may perform switching of the storage device for use. Thus, the control device 100 may reduce delay in response to the host device 202 when rearrangement of data of the logical volume is performed.

### Second Operation Example

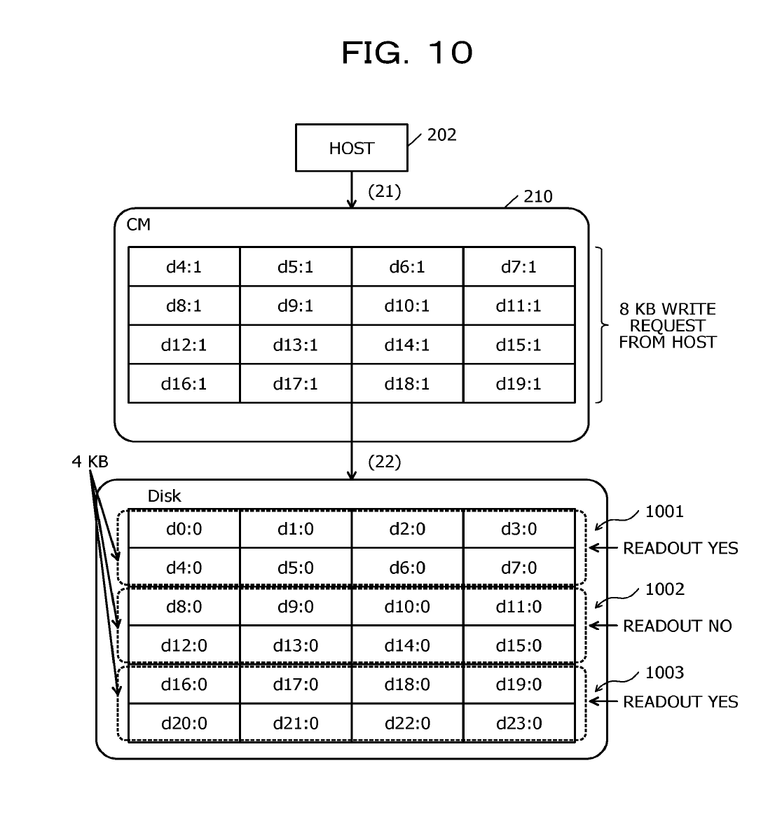

Next, a second operation example of the control device 100 will be described with reference to FIG. 10 to FIG. 12. The second operation example is an example of an operation performed in a case where, in performing a write of data for which a write request was made, the control device 100 performs a read-modify-write.

### Example In Which Write Request For Data Write Request Is Received

FIG. 10 is an explanatory diagram illustrating an example in which the control device 100 receives a data write request in the second operation example. In FIGS. 10, d0:0 to d23:0 and the like are stored in a disk of the storage device 220. In the reference character dx:y, x is the number of data. In the reference character dx:y, y is the version of data.

(21) The control device 100 receives, from the host device 202, 0x200 write requests to the logical volume. The received write requests include write requests for writing pieces of data that are to be written to a memory area that is not a sector unit.

(22) Because the received write requests are write requests for writing data to a memory area that is not a sector unit, the control device 100 reads out correction data used for correcting data to data that may be written in a memory area in units of sectors from the storage device 220. Next, the control device 100 corrects the pieces of data for which the write requests were made by combining the readout correction data and the pieces of data for which the write requests were made together. The control device 100 performs a write of the pieces of data, which have been corrected, to the storage device 220.

Specifically, when the control device 100 receives write requests for writing data d4:1 to data d19:1, the control device 100 reads out data d0:0 to data d7:0 that are pieces of correction data for a sector 1001. Next, the control device 100 generates, as corrected data d0:1 to corrected data d7:1, pieces of data obtained by overwriting the data d4:1 to the data d7:1 on the data d4:0 to the data d7:0 among the data d0:0 to the data d7:0 that have been read out. Then, the control device 100 performs a write of the corrected data d0:1 to the corrected data d7:1 to the sector 1001.

Also, the control device 100 performs a write of data d8:1 to d15:1 for a sector 1002. In this case, the control device 100 does not perform a read-modify-write and thus does not read out correction data, and therefore, a write performance is not reduced.

Also, the control device 100 reads out data d16:0 to data d23:0 that are correction data for a sector 1003. Next, the control device 100 generates, as corrected data d16:1 to corrected data d19:1, data obtained by overwriting data d16:1 to data d19:1 on the data d16:0 to the data d19:0 among the data d16:0 to the data d23:0 that have been read out. Then, the control device 100 performs a write of the corrected data d16:1 to the corrected data d23:1 to the sector 1003.

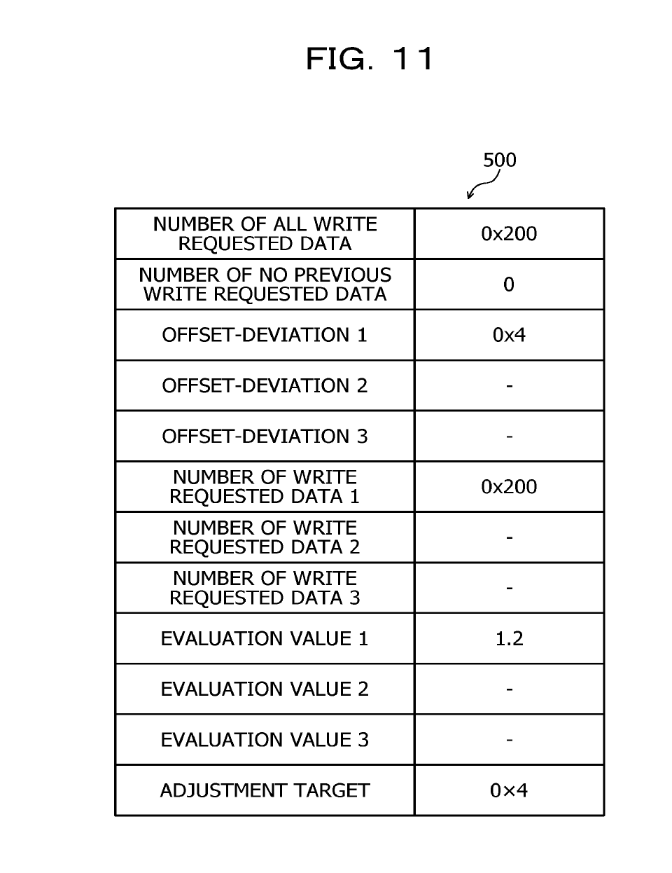

FIG. 11 will be described hereinafter. As will be described later with reference to FIG. 11, the control device 100 updates the offset table 500, based on the received write requests in FIG. 10. Then, the control device 100 determines the offset 2 in the offset 2 entry in the management table 400 with reference to the offset table 500.

### Example In Which Offset 2 Is Determined

FIG. 11 is an explanatory table illustrating an example in which the control device 100 determines the offset 2 in the second operation example. The control device 100 sets the number “0x200”, which is the number of the write requests received in FIG. 10, to the number-of-all-write-requested-data entry in the offset table 500.

The control device 100 sets “0”, which is the number of write requests for data that may be written without performing a write penalty and a read-modify-write, among the write requests received in FIG. 10, to the number-of-no-previous-write-requested-data entry in the offset table 500.

The control device 100 calculates, for each of the write requests received in FIG. 10, a deviation amount of a write position from a boundary of a memory area that is a management unit. For example, the control device 100 calculates “0x4” as the deviation amount. Then, the control device 100 sets the deviation amount “0x4”, which has been calculated, to the offset-deviation 1 entry in the offset table 500. If there is a different deviation amount from the deviation amount in the offset-deviation 1 entry, among the deviation amounts that have been calculated, the control device 100 sets the different deviation amount to the offset-deviation 2 entry and the offset-deviation 3 entry.

The control device 100 sets the number “0x200”, which is the number of write requests for which the calculated deviation amount is the deviation amount “0x4” in the offset-deviation 1 entry, to the number-of-write-requested-data 1 entry. If there are deviation amounts that have been set to the number-of-write-requested-data 2 entry and the number-of-write-requested-data 3 entry, similar to the number-of-write-requested-data 1, the control device 100 updates the number-of-write-requested-data 2 entry and the number-of-write-requested-data 3 entry.

The control device 100 calculates the evaluation value “1.2” of the access performance of the logical volume when data of the logical volume is rearranged on the physical area of the storage device 220, based on the deviation amount in the offset-deviation 1 entry. Then, the control device 100 sets the evaluation value “1.2”, which has been calculated, to the evaluation-value 1 entry. If there are deviation amounts that have been set to the offset deviation 2 entry and the offset deviation 3 entry, similar to the evaluation-value 1, the control device 100 updates the evaluation-value 2 entry and the evaluation-value 3 entry.

The control device 100 specifies, among the deviation amounts that have been set to the offset-deviation 1 entry, the offset-deviation 2 entry, and the offset-deviation 3 entry, the deviation amount “0x4” with which the evaluation value is the largest. Then, the control device 100 sets the deviation amount “0x4”, which has been specified, to the adjustment target entry.

Furthermore, the control device 100 calculates a difference “0x4” obtained by subtracting the deviation amount “0x4”, which has been set to the adjustment target entry, from the size “0x8” of the sector. Then, the control device 100 determines the difference “0x4”, which has been calculated, as the offset 2. The control device 100 updates the offset 2 entry in the management table 400 with the determined offset 2.

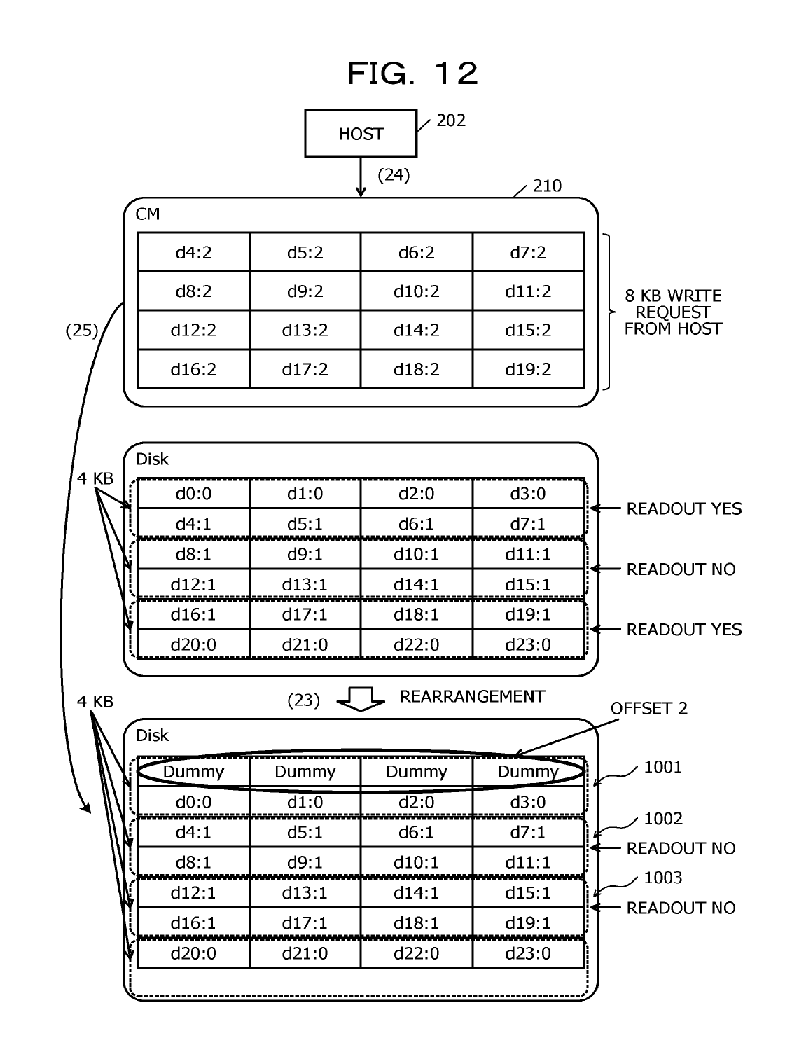

Next, FIG. 12 will be described. As will be described in FIG. 12, the control device 100 rearranges data of the logical volume on the physical area of one of the storage device 220, based on the determined offset 2.

### Example In Which Data Of Logical Volume Is Rearranged

FIG. 12 is an explanatory diagram illustrating an example in which the control device 100 rearranges data of a logical volume in the second operation example. In FIG. 12, (23) the control device 100 inserts dummy data that has the same size as that of the determined offset 2 in the head of the data of the logical volume, and thus, rearranges the data. Thus, the control device 100 moves the data d4:1 to the data d11:1 such that the data d4:1 to the data d11:1 are stored in a memory area that is a sector unit.

(24) The control device 100 receives, from the host device 202, write requests for writing data d4:2 to data d19:2 to the logical volume in a similar manner to that in FIG. 10. In this case, because the write requests are received after rearrangement is performed in (23), the write requests for writing the data d4:2 to the data d19:2 are write requests for writing pieces of data in a memory area in units of sectors.

(25) Because the received write requests are write requests for writing pieces of data to a memory area in units of sectors, the control device 100 does not read out correction data from the storage device 220. The control device 100 performs a write of the pieces of data for which the write requests were made to the storage device 220.

Specifically, when the control device 100 receives write requests for writing the data d4:2 to the data d19:2, the control device 100 performs a write of the data d4:2 to the data d11:2 to the sector 1002. Also, the control device 100 performs a write of the data d12:2 to the data d19:2 to the sector 1003.

As described above, as a result of the rearrangement of the data of the logical volume, when the control device 100 receives data write requests that are similar to those of FIG. 10, the control device 100 is enabled to perform a data write without performing a read-modify-write. Thus, the control device 100 may reduce reduction in write performance to the logical volume.

### Example of Generation Processing Steps

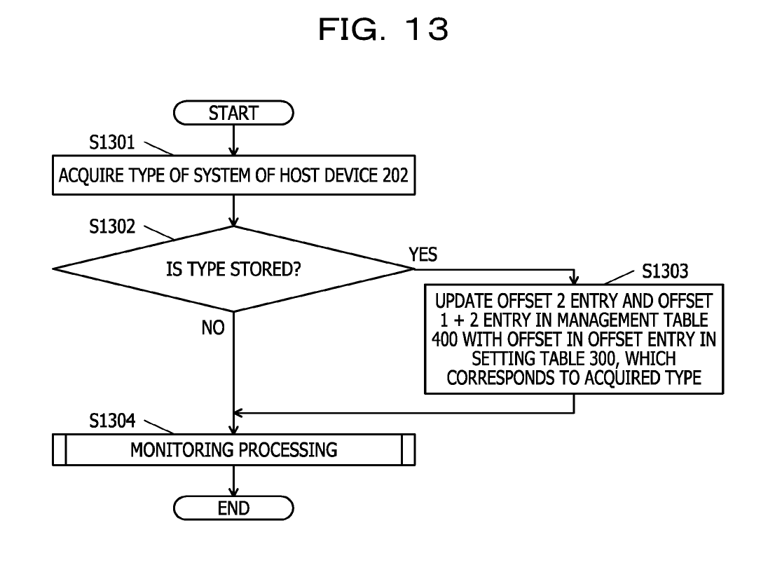

Next, an example of generation processing steps will be described with reference to FIG. 13.

FIG. 13 is a flow chart illustrating an example of generation processing steps. In FIG. 13, the control device 100 acquires the type of a system of the host device 202 (Step S1301). Next, the control device 100 determines whether or not the acquired type is stored in the type entry in the setting table 300 (Step S1302). If the acquired type is not stored in the type entry (NO in Step S1302), the control device 100 causes the process to proceed to processing of Step S1304.

On the other hand, if the acquired type is stored in the type entry (YES in Step S1302), the control device 100 updates the offset 2 entry and the offset 1+2 entry in the management table 400 with an offset in the offset entry in the setting table 300, which corresponds to the acquired type (Step S1303). Then, the control device 100 causes the process to proceed to the processing of Step S1304.

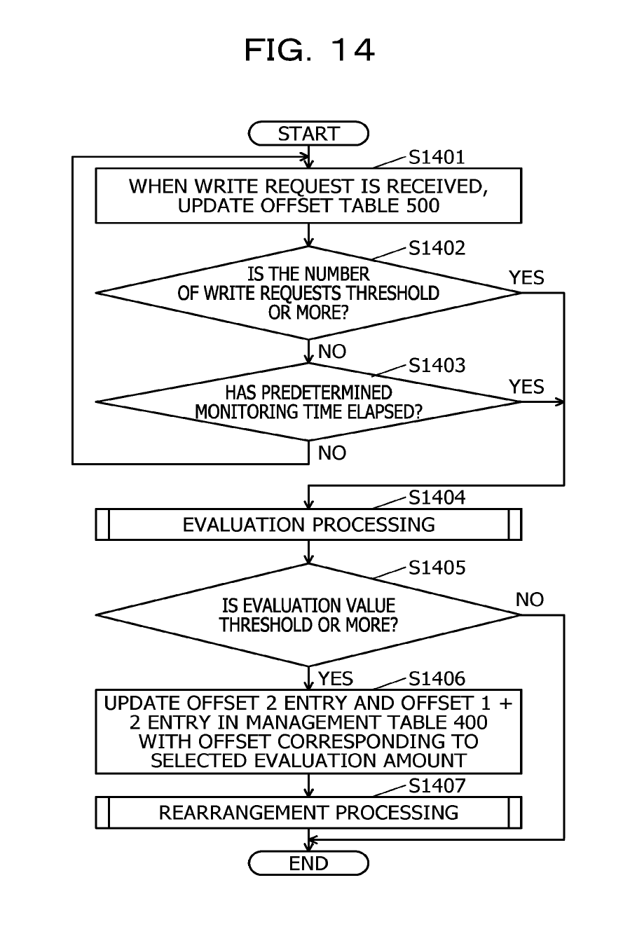

In Step S1304, the control device 100 executes monitoring processing, which will be described later with reference to FIG. 14 (Step S1304).

Then, the control device 100 terminates generation processing. Thus, the control device 100 generates a logical volume in the storage device 220.

### Example of Monitoring Processing Steps

Next, an example of monitoring processing steps executed in Step S1304 in FIG. 13 will be described with reference to FIG. 14.

FIG. 14 is a flow chart illustrating an example of monitoring processing steps. In FIG. 14, when the control device 100 receives a write request, the control device 100 updates the offset table 500 (Step S1401). Next, the control device 100 determines whether or not the number of received write requests is a threshold or more (Step S1402).

If the number of received write requests is not the threshold or more (NO in Step S1402), the control device 100 determines whether or not a predetermined monitoring time has elapsed since a start of monitoring processing (Step S1403). If the predetermined monitoring time has not elapsed (NO in Step S1403), the control device 100 causes the process to return to the processing of Step S1401.

On the other hand, if the number of received write requests is the threshold or more in Step S1402 (YES in Step S1402), or if the predetermined monitoring time has elapsed in Step S1403 (YES in Step S1403), the control device 100 causes the process to proceed to Step S1404.

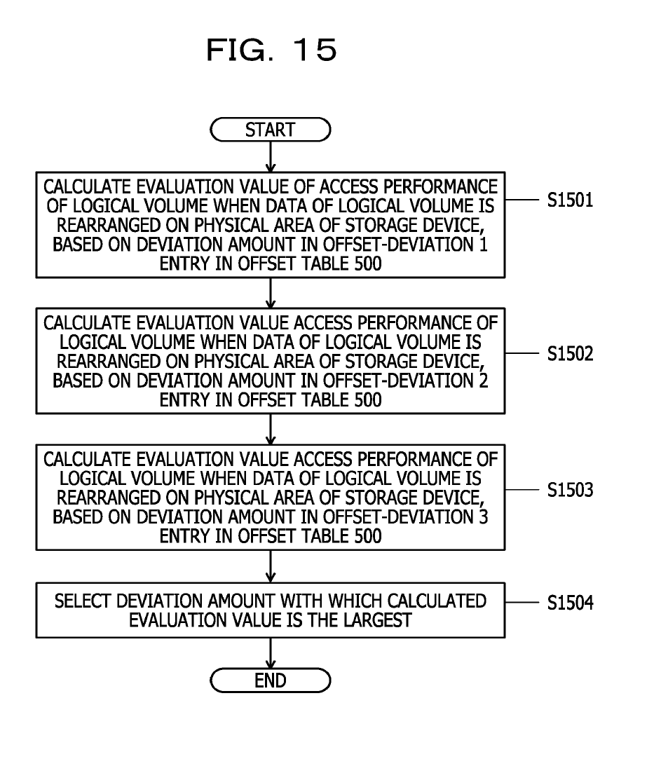

In Step S1404, the control device 100 executes evaluation processing, which will be described later with reference to FIG. 15 (Step S1404). Next, the control device 100 determines whether or not an evaluation value is a threshold or more (Step S1405). If the evaluation value is not the threshold or more (NO in Step S1405), the control device 100 terminates monitoring processing without updating the offset 2 entry and the offset 1+2 entry in the management table 400.

On the other hand, if the evaluation value is the threshold or more (YES in Step S1405), the control device 100 updates the offset 2 entry and the offset 1+2 entry in the management table 400 with an offset corresponding to a deviation amount selected in evaluation processing, which will be described later (Step S1406).

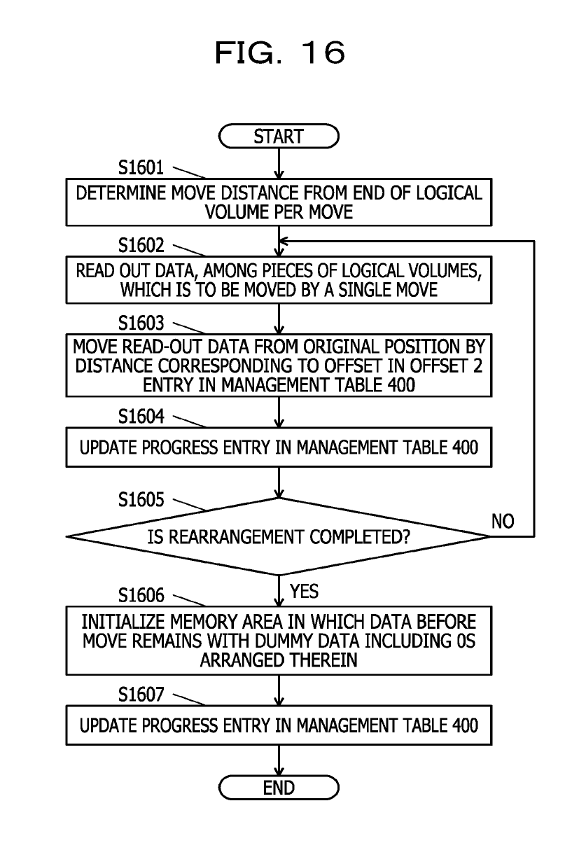

Next, the control device 100 executes rearrangement processing, which will be described later with reference to FIG. 16 (Step S1407). Then, the control device 100 terminates monitoring processing. Thus, the control device 100 calculates, for each data for which a write request was made, a deviation amount of a write position from a boundary of a memory area that is a management unit.

### Example of Evaluation Processing Steps

Next, an example of evaluation processing steps executed in Step S1404 in FIG. 14 will be described with reference to FIG. 15.

FIG. 15 is a flow chart illustrating an example of evaluation processing steps. In FIG. 15, the control device 100 calculates the evaluation value of the access performance of a logical volume when data of the logical volume is rearranged on the physical area of the storage device 220, based on the deviation amount in the offset-deviation 1 entry in the offset table 500 (Step S1501).

Next, the control device 100 calculates the evaluation value of the access performance of the logical volume when data of the logical volume is rearranged on the physical area of the storage device 220, based on the deviation amount in the offset-deviation 2 entry in the offset table 500 (Step S1502). Then, the control device 100 calculates the evaluation value of the access performance of the logical volume when data of the logical volume is rearranged on the physical area of the storage device 220, based on the deviation amount in the offset-deviation 3 entry of the offset table 500 (Step S1503).

Next, the control device 100 selects the deviation amount with which the calculated evaluation value is the largest (Step S1504). Then, the control device 100 terminates evaluation processing. Thus, the control device 100 selects the deviation amount used in rearranging data of the logical volume on the physical area.

### Example of Rearrangement Processing Steps

Next, an example of rearrangement processing steps executed in Step S1407 in FIG. 14 will be described with reference to FIG. 16.

FIG. 16 is a flow chart illustrating an example of rearrangement processing steps. In FIG. 16, the control device 100 determines a move distance from the end of the logical volume per move (Step S1601). Next, the control device 100 reads out data, among pieces of data of the logical volume, which is moved by a single move (Step S1602). Then, the control device 100 moves the read-out data from an original position by a distance corresponding to an offset in the offset 2 entry in the management table 400 (Step S1603).

Next, the control device 100 updates the progress entry in the management table 400 (Step S1604). Then, the control device 100 determines whether or not rearrangement is completed (Step S1605). If the rearrangement is not completed (NO in Step S1605), the control device 100 causes the process to return Step S1602.

On the other hand, if the rearrangement is completed (YES in Step S1605), the control device 100 initializes the memory area in which data before the move remains with dummy data including 0s arranged therein (Step S1606). Next, the control device 100 updates the progress entry in the management table 400 (Step S1607). Then, the control device 100 terminates rearrangement processing. Thus, the control device 100 rearranges data of the logical volume.

As described above, the control device 100 calculates, based on a write position of data for which a data write request to a logical volume was made, a deviation amount of the write position from a boundary of a memory area that is a management unit on the logical volume. Then, the control device 100 rearranges the data of the logical volume on the physical area of the storage device 220, based on the calculated deviation amount. Thus, the control device 100 deviates a head position of the logical volume in accordance with the deviation amount. As a result, when the size and write position of data for which a write request is made next time or later are the same as the size and write position of data for which a write request was made this time, the control device 100 may reduce reduction in write performance.

Also, the control device 100 calculates the deviation amount of the write position from a boundary of a stripe on the logical volume. Then, the control device 100 rearranges, based on the calculated deviation amount, data of the logical volume on the physical area of the storage device 220. Thus, the control device 100 deviates the head position of the logical volume in accordance with the deviation amount such that a data write may be performed even without performing a write penalty. As a result, when the size and write position of data for which a write request is made next time or later are the same as the size and write position of data for which the write request was made this time, the control device 100 is enabled to perform a data write without performing a write penalty. Thus, the control device 100 may reduce reduction in write performance.

Also, when the size of data matches an integral multiple of the size of a stripe, the control device 100 calculates, as the deviation amount, the value of a remainder when the address of the write position is divided by the size of the stripe. Thus, even when the head position of the logical volume is deviated, the control device 100 does not calculate a deviation amount for data that may not be written without performing a write penalty, and may reduce a processing load.

Also, the control device 100 calculates the deviation amount of the write position from a boundary of a sector on the logical volume. The control device 100 rearranges, based on the calculated deviation amount, data of the logical volume on the physical area of the storage device 220. Thus, the control device 100 deviates the head position of the logical volume such that data may be written in accordance with the deviation amount without performing a read-modify-write. As a result, when the size and write position of data for which a write request is made next time or later are the same as the size of write position of data for which a write request was made this time, the control device 100 is enabled to perform a write without performing a read-modify-write. Thus, the control device 100 may reduce reduction in write performance.

Also, when the size of data matches an integral multiple of the size of a sector, the control device 100 calculate, as the deviation amount, the value of a remainder when the address of the write position is divided by the size of the sector. Thus, even when the head position of the logical volume is deviated, the control device 100 does not calculate the deviation amount for data that may not be written without performing a read-modify-write, and may reduce a processing load.

Also, the control device 100 calculates, for each data for which a write request to the logical volume was made, the deviation amount of the write position of data from a boundary of a memory area that is a management unit. Next, the control device 100 calculates, based on the number of deviation amounts, among deviation amounts that have been calculated for each data, respective values of which are the same, the evaluation value of the access performance when data of the logical volume is rearranged, based on each of the deviation amounts that have been calculated for each data. Then, the control device 100 rearranges data of the logical volume on the physical area of the storage device 220, based on the deviation amount with which the calculated evaluation value is the largest. Thus, the control device 100 selects the deviation amount and rearranges data of the logical volume such that reduction in write performance may be statistically reduced most.

Also, the control device 100 inserts dummy data that has a size corresponding to the deviation amount in the head or end of data of the logical volume, and thus, rearranges data on the physical area of the storage device 220. Thus, the control device 100 overwrites data that has been originally located on the physical area with the dummy data. As a result, the control device 100 may reduce a chance of reading out the data that has been originally located on the physical area by mistake. Also, the control device 100 may ensure security.

Also, a case where, a known arithmetic device deviates, for each data for which a write request was made, the write position of data to a position that is a boundary of a memory area that is a management unit on the logical volume. However, in this case, in the known arithmetic device, when a write request for data for which a write position that does not match the position that is the boundary of the memory area that is a management unit on the logical volume is designated is frequently made, a write performance might be reduced. Also, because the known arithmetic device deviates the write position for each data for which a write request was made, an unused memory area might be thereby increased. On the other hand, the control device 100 does not perform processing of deviating the write position of each data for which a write request was made, and therefore, reduction in write performance may be reduced. Also, the control device 100 does not perform deviation of the write position for each data for which a write request was made, and therefore, increase in unused memory area may be reduced.

A case where the control device 100 calculates the deviation amount, based on the write position of data for which a write request was made, has been described above, but the embodiment is not limited thereto. For example, the control device 100 may use a read request, instead of a write request. Specifically, the control device 100 calculates, based on the size and read position of data for which a read request was made to a logical volume, the deviation amount of the read position from a boundary of a memory area that is a management unit on the logical volume.

Note that the control method described in this embodiment may be realized by causing a computer, such as a personal computer, a work station, and the like, to execute a control program prepared in advance. The control program is recorded in a computer-readable recording medium, such as a hard disk, a flexible disk, a CD-ROM, a MO, a DVD, and the like, is read out from the recording medium by the computer. Also, the program may be distributed via a network, such as the Internet and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention. cm What is claimed is:

1. A system comprising:
circuitry configured to
set a logical volume in a first physical address region of a storage device including a plurality of memory areas;
receive a write request to write data to a first logical address of the logical volume;
calculate a difference between a first physical address corresponding to the first logical address and a head physical address of a first memory area of the plurality of memory areas;
change, based on the calculated difference, a first physical address region of the logical volume in the storage device to a second physical address region of the storage device; and
write the data to the first logical address of the logical volume set in the second physical address region of the storage device.

2. The system of claim 1, wherein
the plurality of memory areas are stripes.

3. The system of claim 2, wherein
the circuitry is configured to calculate, as the difference, a value of a remainder when the first logical address is divided by a size of the stripe when a size of the data matches an integral multiple of the size of the stripe.

4. The system of claim 2, wherein
the stripe includes at least one of a plurality of magnetic disks, a plurality of optical disks, a plurality of flash memories, and a plurality of magnetic tapes.

5. The system of claim 4, wherein the circuitry is configured to:
calculate parity data based on the data to be stored in the stripe; and
write the data into the storage device and the parity data into other storage device.

6. The system of claim 5, wherein
the circuitry is configured to calculate the parity data based on the data to be stored in the stripe without executing a reading process.

7. The system of claim 1, wherein
the plurality of memory areas are sectors.

8. The system of claim 7, wherein
the circuitry is configured to calculate, as the difference, a value of a remainder when the first logical address is divided by a size of the sector when a size of the data matches an integral multiple of the size of the sector.

9. The system of claim 1, wherein
the circuitry is configured to calculate a difference between each head physical address of the plurality of memory areas and each of a plurality of logical addresses when a plurality of data write requests for writing a plurality of pieces of data to a plurality of logical addresses of the logical volume are received.

10. The system of claim 9, wherein
the circuitry is configured to calculate an evaluation value of an access performance when the first physical address of the logical volume in the storage device is changed based a number of differences among a plurality of differences that have been calculated.

11. The system of claim 10, wherein
the circuity is configured to change the first physical address region of the logical volume in the storage device based on a difference with which the evaluation value that has been calculated is the largest.

12. The system of claim 1, wherein
the circuitry is configured to insert dummy data that has a size corresponding to the difference in a head portion or end portion of the logical volume thereby changing the first physical address region of the logical volume in the storage device to the second physical address region of the storage device.

13. The system of claim 1, wherein
the second physical address region of the storage device matches the head physical address of the first memory area.

14. The system of claim 1, wherein
the system is a control device including a processor and a communication interface configured to communicate with the storage device.

15. The system of claim 1, wherein
the system comprises a plurality of control devices each including a processor and a communication interface configured to communicate with the storage device.

16. The system of claim 1, wherein
the circuitry includes a processor and a memory coupled to the processor, and the processor executes computer program stored in the memory.

17. A method comprising:
setting a logical volume in a first physical address region of a storage device including a plurality of memory areas;
receiving a write request to write data to a first logical address of the logical volume;
calculating a difference between a first physical address corresponding to the first logical address and a head physical address of a first memory area of the plurality of memory areas;
changing, based on the calculated difference, a first physical address region of the logical volume in the storage device to a second physical address region of the storage device; and
writing the data to the first logical address of the logical volume set in the second physical address region of the storage device.

18. A non-transitory computer-readable medium configured to store a computer program, which when executed by a system, cause the system to:
set a logical volume in a first physical address region of a storage device including a plurality of memory areas;
receive a write request to write data to a first logical address of the logical volume;
calculate a difference between a first physical address corresponding to the first logical address and a head physical address of a first memory area of the plurality of memory areas;
change, based on the calculated difference, a first physical address region of the logical volume in the storage device to a second physical address region of the storage device; and
write the data to the first logical address of the logical volume set in the second physical address region of the storage device.
